(19) United States
(12) Patent Application Publication
(10) Pub. No.: US 2014/0229602 A1
(43) Pub. Date: Aug. 14, 2014

(54) MANAGEMENT OF NODE MEMBERSHIP IN A DISTRIBUTED SYSTEM

(71) Applicant: INTERNATIONAL BUSINESS MACHINES CORORATION, (US)

(72) Inventors: David R. Engebretsen, Cannon Falls, MN (US); David L. Hermsmeier, Oronoco, MN (US); Stephen A. Knight, Rochester, MN (US); Adam C. Lange-Pearson, Rochester, MN (US); Paul E. Movall, Rochester, MN (US)

(73) Assignee: INTERNATIONAL BUSINESS MACHINES CORPORATION, Armonk, NY (US)

(21) Appl. No.: 13/762,605

(22) Filed: Feb. 8, 2013

(51) Int. Cl. H04L 29/08

(52) U.S. Cl. CPC H04L 29/08099
USPC 709/224

(57) ABSTRACT

Systems and methods of managing computing node membership are present. A particular method may include determining that a node group universally unique identifier has not been assigned to a computing node. In response to the determination, the method may include transitioning the computing node into a first state, where the computing node awaits an invitation relating to forming or joining a node group while in the first state and transitioning the computing node into a second state in response to receiving the invitation to form or join the node group, where the computing node awaits an assignment of the node group universally unique identifier while in the second state. The computing node may transition into a third state in response to receiving the node group universally unique identifier, where the computing node is configured to locate a plurality of neighboring nodes while operating in the third state, and the method may determine whether a quorum of nodes including the neighboring nodes is present.

### I. FIELD OF THE DISCLOSURE

The present disclosure relates generally to the management of computer networks, and more particularly, to managing computing nodes in distributed computing environment.

### II. BACKGROUND

Computing elements, or nodes, may be clustered or otherwise grouped to provide a unified computing capability. From the perspective of the end user, the cluster operates as a single system. Work can be distributed across multiple systems within the cluster. Single outage in the cluster will not disrupt the services provided to the end user. Techniques exist to form groups of distributed systems and to establish associated network connections between those group members. However, conventional techniques rely heavily on direct user interaction to define the elements of each group. Such techniques additionally require high level networks that execute Transmission Control Protocol/Internet Protocol (TCP/IP) stack protocols.

### III. SUMMARY OF THE DISCLOSURE

According to a particular embodiment, a method of managing computing node membership may include determining that a node group universally unique identifier has not been assigned to a computing node. In response to the determination, the method may include transitioning the computing node into a first state, where the computing node awaits an invitation relating to forming or joining a node group while in the first state and transitioning the computing node into a second state in response to receiving the invitation to form or join the node group, where the computing node awaits an assignment of the node group universally unique identifier while in the second state. The computing node may transition into a third state in response to receiving the node group universally unique identifier, where the computing node is configured to locate a plurality of neighboring nodes while operating in the third state, and the method may determine whether a quorum of nodes including the neighboring nodes is present.

Features and benefits that characterize embodiments are set forth in the claims annexed hereto and forming a further part hereof. However, for a better understanding of the embodiments, and of the advantages and objectives attained through their use, reference should be made to the Drawings and to the accompanying descriptive matter.

### IV. BRIEF DESCRIPTION OF THE DRAWINGS

FIG. 1 is a block diagram of a single computing node configured to manage node operations according to an embodiment;

FIG. 2 is a block diagram of a computing system that includes the node of FIG. 1 conducting node operations with another node in accordance with an embodiment;

FIG. 3 is a block diagram of a computing system that includes multiple nodes forming a node group in accordance with an embodiment;

FIG. 4 is a flowchart of a method of managing multiple nodes according to an embodiment; and

FIG. 5 is a block diagram of a computing apparatus including software and hardware to monitor and verify switch frame delivery in a manner consistent with an embodiment.

### V. DETAILED DESCRIPTION

Embodiments of a system may manage a distributed set of processing nodes that join together to operate as a single collective. In a particular implementation, each node may begin in an initial state (i.e., a genesis state) until the node is discovered by and accepted into an existing node group. The nod then becomes a full member of that node group. Where there is no existing group, a process may be defined to initiate formation of a new group under end user direction.

Conventional group formation techniques rely on high level networks running TCP/IP stack protocols. Embodiments may combine minimal user interaction to initiate the formation of a group or the removal of nodes from the group with autonomous firmware procedures. The firmware procedures may use the input to automatically aggregate additional members into the group and fully manage all dynamic group membership during system events, such as reboot cycles. Embodiments may be built on a limited network capability where nodes may communicate only with their nearest neighbor via a point to point connection.

An embodiment of a system may create a worldwide unique name for a distributed collection of processing elements, or nodes. The nodes may have been defined to operate as a singular entity called a node group. Initially, an end user may define those nodes that are to be in the group via command line interface interaction with a single node to initiate the group formation. Physical network connectivity may be established between all of the nodes that are automatically added to the node group by firmware based on the network topology.

Once a node has been added to a given node group, the node may remain a member of that group until direct user interaction is used to revoke the group membership of the node. Except at initial formation and node removal, all other group management may automatically be performed by firmware running on each node through a distributed algorithm.

An embodiment of a method may be used to identify which nodes are allowed to communicate on a given network fabric and to facilitate initialization of that fabric. The network fabric may be defined to be a mesh topology where all nodes have point to point connectivity to all other nodes. Node to node communication over the network may be performed by a low level mailbox based mechanism that allows neighboring nodes to exchange messages.

The low level mailbox mechanism may not include TCP/IP protocols. The low level mailbox communication may use the fabric topology. Nodes may only communicate with peer nodes that have a direct physical connection to them. In addition, a node may not broadcast its identity (as is typical on Ethernet) to other nodes. The node may be discovered by a peer node via a query over the link to a mailbox register.

An embodiment of a system may include a group of independent computing nodes that are physically connected by a mesh topology point to point communications network between each pair of nodes. Each node is able to communicate over this network with its peers via a simple mailbox mechanism that exists between each neighboring pair of nodes. Each node may have direct connectivity over a network link to all other nodes. Direct connectivity may be realized either via a point to point link or through a cross bar switch configured to provide direct node to node connectivity. Each node may join only a single node group (comprising a set of multiple nodes). Moreover, each node may exclusively remain a member of that node group until an end user requests that the node be removed from the node group.

Group membership for each node on the network may be defined by one of two states. For example, a genesis state may indicate that a node is not a member of any node group. A group member state may indicate that a node is a member of a specific node group. The node may further have been assigned a node group universally unique identifier (NG-UUID). This identifier may be universally unique.

A node may transition from the genesis state to the group member state through one of two processes. Namely, an end user may explicitly requests that a given node form a new node group via a command line interface (CLI) in system firmware. In another transition process, the node may be connected via a communications network to a node that is already a node group member.

A node may transition from the group member state to the genesis state when an end user explicitly requests that a given node be removed from a node group. In one example, a request may be made using a command line interface in system firmware.

Nodes may operate in one of two runtime states. More particularly, a node that is in a node initializing state may be in a boot process and may be waiting to locate a sufficient set of nodes from a defined node group. A node that is in a node operational state may have full run-time capability and may be considered fully initialized.

Network communication may be defined using several processes. For instance, a nearest neighbor communication via a simple mailbox protocol may be employed. When operating in this protocol, no traditional generalized network addressing may be used to communicate a message to another node, as the target of a given message is strictly defined by the physical links between the two nodes that are communicating. In another example, network communications may be defined by fully qualified network addressing processes that use a generalized look up mechanism to route packets between any nodes on the network based on node identifiers in each packet. This mode may be used to carry normal functional path network traffic (e.g. Ethernet frames) from any node to any node that has been added to the node group. Another network communication may involve each node controlling a communications node that may be used over links connected to it. When a link is put in a link fenced state, only nearest neighbor communication may flow (e.g., no functional path traffic may flow). When a link is not in the fenced state it is link operational, and any form of traffic may flow over that link. The fenced state may be used by nodes to block traffic from other nodes with which it is not part of a node group.

When a node in genesis state is added to an already initialized node group, the node may be assigned parameters by a single master node. The master node may have been elected by the node group members. A node may remain in the genesis state until the master node initializes the node, or an end user indicates (via a CLI) that the node should transition to group member state. Once a node has transitioned out of the genesis state, the CLI interface to change state into the group member state may no longer be allowed until the node has been returned to genesis state.

Multiple operating rules may pertain to NG-UUID management. For example, all nodes in a given group may have the same NG-UUID. The NG-UUID of the group may be initially created by the firmware running on a single master node. Two nodes that have different NG-UUIDs may be prevented from joining into a single node group, or even flowing functional path traffic over the network connecting the nodes. All network interfaces may be kept in the fence state, only allowing the low-level protocol used to detect the NG-UUID of the node on the other side of the point to point network link NG-UUID assignment may occur when a node enters into a node group. Assignment may occur when a CLI is used by an end user to direct the node to form a node group. An assignment may also occur when a node with no assigned NG-UUID (e.g., a node in the genesis state) is physically attached (via the point to point network) to a node that is already in a functioning node group with an assigned NG-UUID. In this case, system firmware may automatically cause the node in genesis state to be added to the node group of the neighboring node.

When a node is assigned an NG-UUID, the value may be stored in persistent storage on the node for use any time the node reboots. As such, nodes may remain in the same defined node group until otherwise directed by an end user. As nodes are added to a node group, each node may maintain a persistently stored node group list that includes members of the node group.

No automatic firmware driven process may remove a node from a group or reassign the NG-UUID of a node once it has been assigned. An end user may manually indicate via a CLI interface that a node is to be decommissioned from its node group. The decommissioning may result in removing the assigned NG-UUID and putting the node in the genesis state. The decommissioned node may remain in genesis state until either a CLI instructs the node to form a new group or the node is reconnected to an existing node group and is rebooted. Once a node becomes part of a given node group, the node may remain a part of that collection until the node is reassigned by an end user.

When a node in the genesis state (e.g., not having an assigned NG-UUID) boots, the node may remain in that state until an NG-UUID is assigned, as described above. When a node in group member state (having an assigned NG-UUID) boots, the node, starts in a node initializing state and uses the mailbox messaging protocol over the network links to discover neighboring nodes. Located neighboring nodes that have the same NG-UUID are part of the same Node Group. The located nodes may have the network link fence removed, and the network connection may move to a full link operational state. The discovery process may continue until a quorum of nodes (defined as greater than one half of nodes in the group) from the node group is found on the network. Determination of a quorum may be made based on the node group list. The set of nodes constituting the quorum may be transitioned into a full node operational state. Until a quorum of nodes is visible to a given node, the node may remain in a node initialization state. Only one set of nodes may enter a node operational state, even if the network is partitioned.

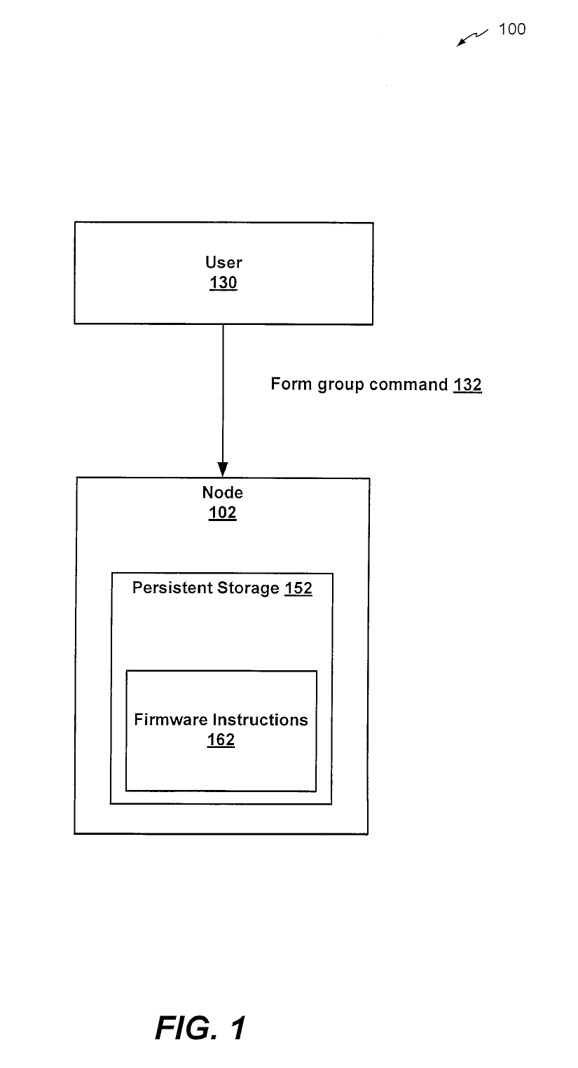

Referring to the Drawings, a particular illustrated embodiment of a system 100 is shown in FIG. 1. FIG. 1 generally illustrates a block diagram of a system 100 comprising a single computing node 102 configured to initiate and manage node operations according to an embodiment. The computing node 102 may be responsive to a user 130. The computing node 102 may comprise a computing device and may include persistent storage 152. For example, the node 102 may include non-volatile random access memory. The persistent storage 152 may include firmware instructions 162. The firmware instructions 162 may include executable code or data or any combination thereof.

Upon booting, the node 102 may determine that it lacks a node group universally unique identifier (NG-UUID) and may enter a first state (e.g., the genesis state). When the computing node 102 is in the genesis state, the computing node 102 may only communicate with other nodes (not shown) that the computing node 102 to which the computing node 102 is directly connected. Furthermore, while the computing node 102 is in the genesis state, the user 130 may send a form group command 132 to the node 102. For instance, the user 130 may send the form group command 132 via a command line interface (CLI) (not shown).

Upon receiving a form group command 132, the computing node 102 may execute code contained in the firmware instructions 162 to generate an NG-UUID (not shown) and may store the NG-UUID in the persistent storage 152. For example, the firmware instructions 162 may generate a random character sequence of a length sufficient to assure that the NG-UUID will not be shared by any other node group (not shown) and may store the character sequence in the persistent storage 152.

Once the node 102 has generated and stored the NG-UUID, the node 102 may enter a second state (e.g., a group member state) as a master node for a new node group (not shown). Upon entering the group member state, the node 102 may not allow the user 130 to issue additional form group commands 132 to node 102. The node 102 may further create a node list (not shown) and may add node 102 to the list. The node list may be stored in persistent storage 152.

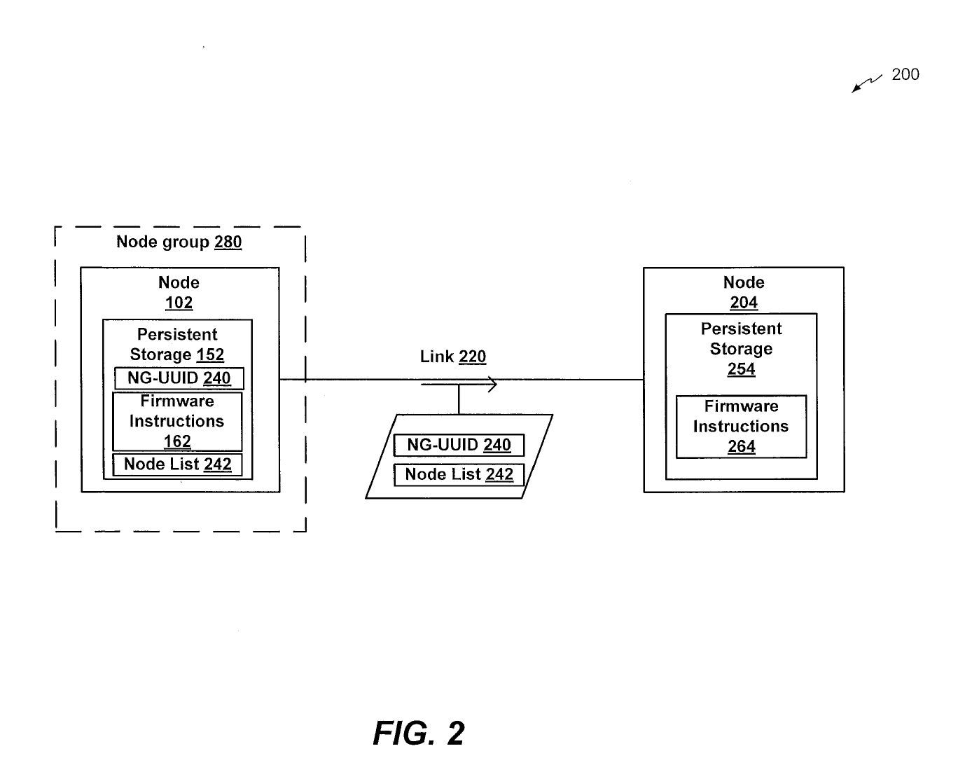

Referring to FIG. 2, a particular illustrated embodiment of the system 200 is shown. The system 200 includes the node 102 of FIG. 1 as well as an additional node 204. Node 102 may be a member of node group 280. Node 102 may include persistent storage 152 and node 204 may include persistent storage 254. Persistent storage 152 may include firmware instructions 162 and persistent storage 254 may include firmware instructions 264. Additionally, persistent storage 152 may include an NG-UUID 240 and node list 242. Node group 280 may be the node group created by node 102, the NG-UUID 240 may be the NG-UUID generated by the firmware instructions 162, and the node list 242 may be the node list created by the node 102 as described above in reference to FIG. 1. The nodes 102, 204 may be coupled by link 220.

The node 204, upon booting, may detect that persistent storage 254 does not contain an NG-UUID and enter into the genesis state. After entering the genesis state, the node 204 may detect that the node 204 is operatively coupled to the node group 280. Upon detecting that the node 204 is coupled to the node group 280, the node 204 may execute code contained within the firmware instructions 264 to join the node group 280. For instance, the node 204 may send a request (not shown) to join the node group 280 over link 220 to node 102 acting as the master node of node group 280. In response to the request, node 102 may add node 204 to the node list 242 and send the NG-UUID 240 and node list 242 to the node 204 adding the node 204 to the node group 280.

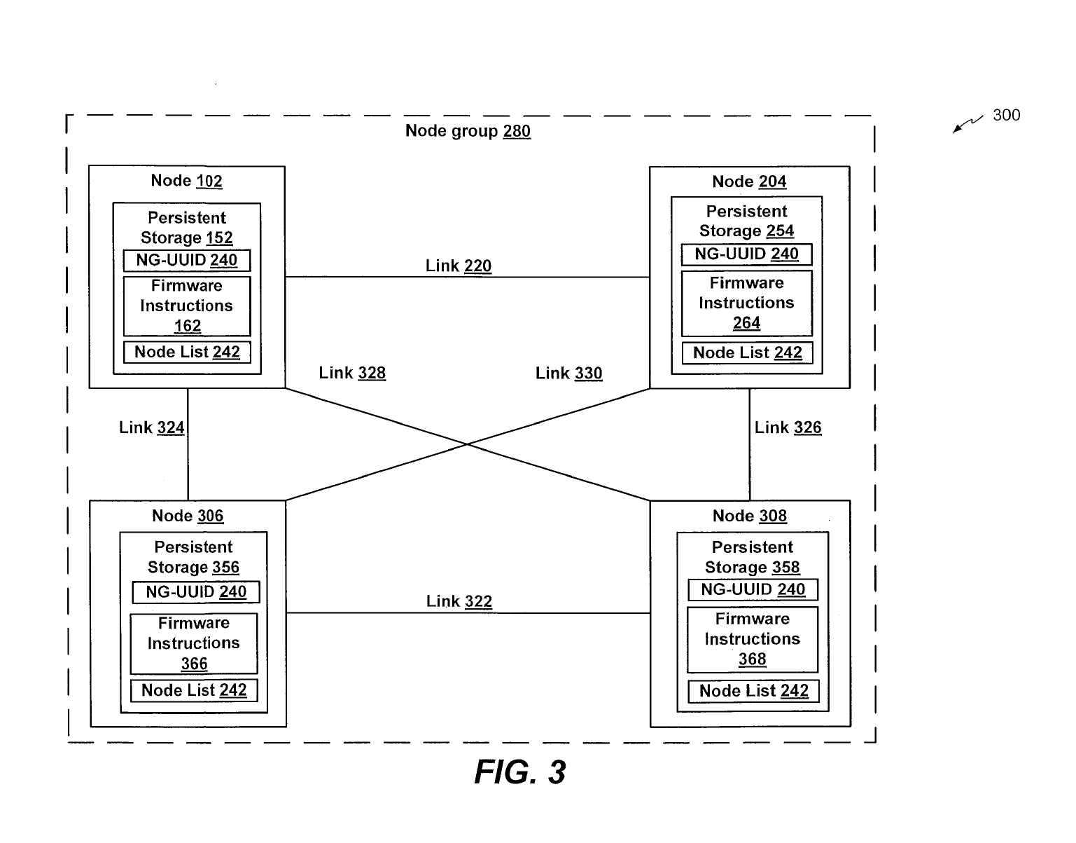

Referring to FIG. 3, a particular embodiment of system 300 is illustrated. System 300 includes the node group 280 of FIG. 2. Node group 280 may include the node 102 of FIGS. 1 and 2, the node 204 of FIG. 2 and the nodes 306 and 308. Node 102 may include the persistent storage 152, node 204 may include the persistent storage 254, node 306 may include the persistent storage 356, and node 308 may include the persistent storage 358. Each of the persistent storage units 152, 254, 356 and 358 may include the NG-UUID 240 and the node list 242. In addition, the persistent storage 152 may include firmware instructions 162, persistent storage 254 may include firmware instructions 264, persistent storage 356 may include firmware instructions 366, and persistent storage 358 may include firmware instructions 368. Node 102 may be operatively coupled to node 204 via link 220, to node 306 via link 324, and to node 308 via link 328. Node 204 may be further operatively coupled to node 306 via link 330 and to node 308 via link 326. Node 308 may be further operatively coupled to node 306 via link 322.

Each node 102, 204, 306, 308, upon booting, may detect NG-UUID 240 and transition to the group member state. Upon entering the group member state, the nodes may transition to a third state (node initialize state). In the node initialize state, a particular node may attempt to discover additional nodes. The particular node may be operatively coupled to and may not be allowed to communicate with nodes to which the particular node is not directly connected or with node groups different from the node group of the particular node. The nodes 102, 204, 306, and 308 may remain in the node initialize state until a quorum has been reached. A quorum is a grouping of more than one half of the nodes in a node list. A quorum is reached when a particular node has discovered one half of the other nodes in the node group of the particular node. Once a quorum has been reached, the nodes in the quorum may enter into a fourth state (node operational state).

Additionally, a node may be placed in a service state. When a particular node is in the service state, the other nodes do not consider the particular node when determining if a quorum has been reached. For example, a user (not shown) may send a message (not shown) to the node 102 acting as the master node of node group 280. The message may instruct node 102 that node 308 is in the service state. In response to the message, node 102 may update the node list 242 and send the update to the nodes 204 and 306. After receiving the update, upon booting, nodes 102, 304 and 306 will not consider node 308 when determining whether a quorum has been reached.

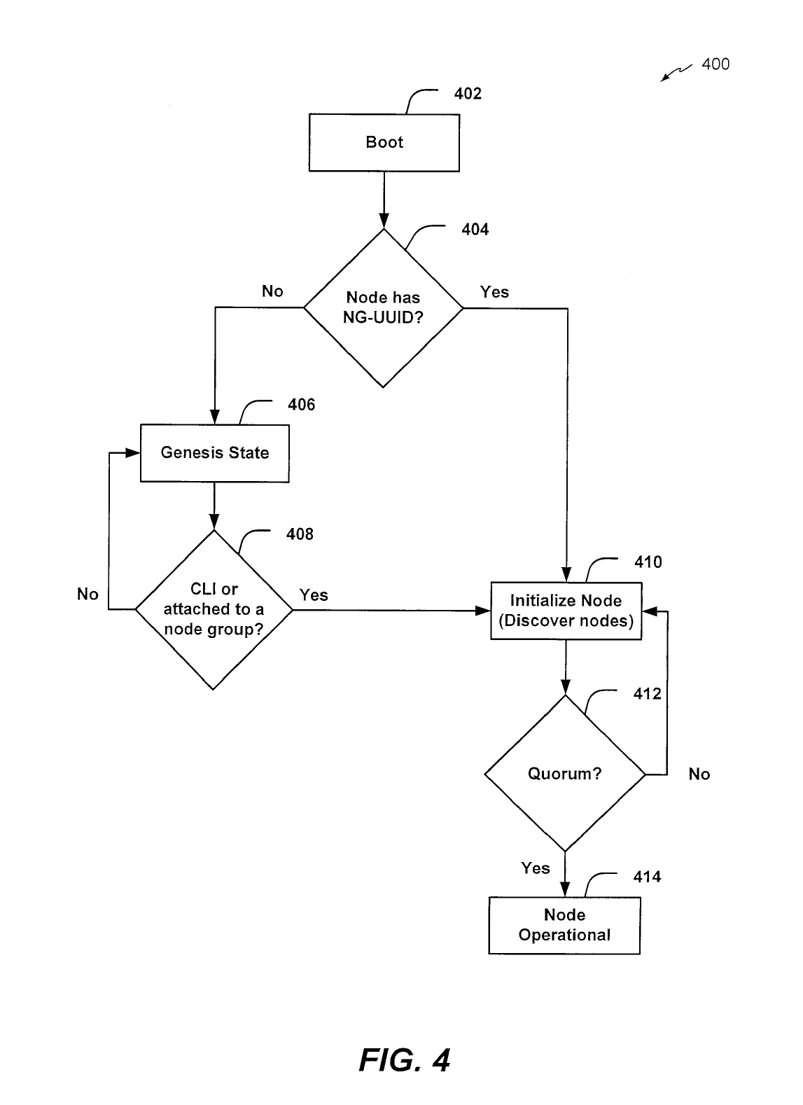

Referring to FIG. 4, a method 400 that may be performed by a node is illustrated. For example, the method 400 may be performed by the node 102 of FIG. 3. At 402, the node may boot and proceed to decision block 404. For example, the node 102 of FIG. 3 may be powered on and boot. At 404, the node may determine whether the node has an NG-UUID stored in the persistent storage of the node. In response to a determination that there is no NG-UUID in the persistent storage, the node proceeds to the genesis state, at 406. For instance, the node 102 of FIG. 1 may determine that the persistent storage 152 does not contain an NG-UUID and may enter the genesis state. At 408, the node determines whether a user has sent a form group command via a CLI or if the node has been coupled to a node group. If the node has not received the form group command or been coupled to a node group, the node may return to 406 and remain in the genesis state.

If the node has received the form group command or been coupled to a node group, the node proceeds to the group member state at 410. For example, the node 102 of FIG. 1 may receive the form group command 132 from the user 130. In response to the form group command 132, the node 102 may execute code included in the firmware instructions 162 to create a node group with an NG-UUID and a node list. The node 102 may enter the group member state. As a further example, the node 204 of FIG. 2 may be connected to the node group 208 and may join the group transitioning to the group member state. The newly joined node 204 may inherits the NG-UUID from the node group to which it has been connected.

Returning to 404, upon determining that the node has an NG-UUID stored in the persistent storage, the node may enter the group member state. For example, the node 102 of FIG. 3 may detect that the persistent storage 152 does include the NG-UIDD 240 and may enter the group member state. At block 412, the node may transition into the initialize node state. For example, the node 102 of FIG. 3 may begin attempting to detect the nodes 204, 306, and 308 of the node list 242. At block 414, the node may determine if a quorum has been reached. When no quorum has been reached, the method 400 returns to block 412 to continue in the initialize node state. For example, the node 102 of FIG. 3 continues in the initialize node state when the node 102 has detected 306, but not nodes 204 and 308 (e.g., one half or more of the nodes of the node list 242 have not been discovered by the node 102).

Returning to 414, when a quorum has been reached, the node may move to 416 and enter the node operational state. For example, the node 102 of FIG. 3 may enter the node operational state when the node 102 has detected the nodes 306 and 308.

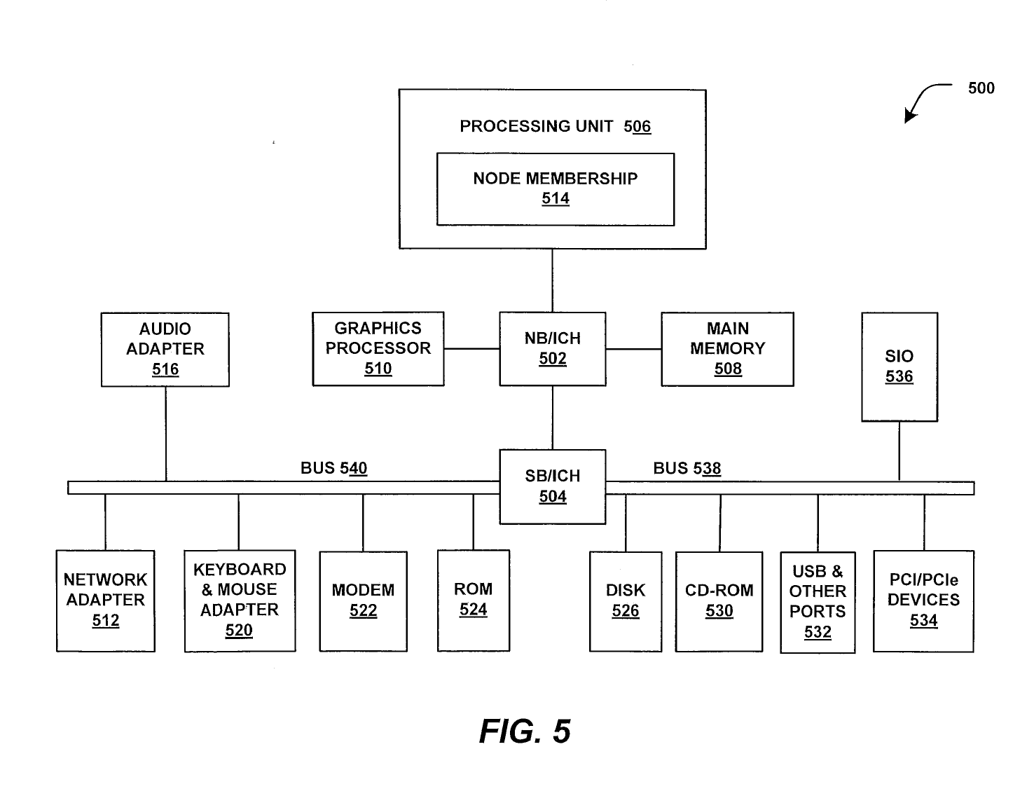

FIG. 5 generally illustrates a block diagram of a computing apparatus 500 consistent with an embodiment. For example, the apparatus 500 may include software and hardware to monitor and verify switch frame delivery. The apparatus 500, in specific embodiments, may include a computer, a computer system, a computing device, a server, a disk array, client computing entity, or other programmable device, such as a multi-user computer, a single-user computer, a handheld device, a networked device (including a computer in a cluster configuration), a mobile phone, a video game console (or other gaming system), etc.

The data processing system may include any device configured to process data and may encompass many different types of device/system architectures, device/system configurations, and combinations of device/system architectures and configurations. Typically, a data processing system will include at least one processor and at least one memory provided in hardware, such as on an integrated circuit chip. However, a data processing system may include many processors, memories, and other hardware and/or software elements provided in the same or different computing devices. Furthermore, a data processing system may include communication connections between computing devices, network infrastructure devices, and the like.

The data processing system 500 is an example of a single processor unit based system, with the single processor unit comprising one or more on-chip computational cores, or processors. In this example, a processing unit 506 may constitute a single chip with the other elements being provided by other integrated circuit devices that may be part of a motherboard, multi-layer ceramic package, or the like, to collectively provide a data processing system, computing device or the like. The processing unit 506 may execute a node membership program 514 to establish and manage node membership in accordance with an embodiment.

In the depicted example, the data processing system 500 employs a hub architecture including a north bridge and a memory controller hub (NB/MCH) 502, in addition to a south bridge and an input/output (I/O) controller hub (SB/ICH) 504. A processing unit 506, a main memory 508, and a graphics processor 510 are connected to the NB/MCH 502. The graphics processor 510 may be connected to the NB/MCH 502 through an accelerated graphics port (AGP).

In the depicted example, a local area network (LAN) adapter 512 connects to the SB/ICH 504. An audio adapter 516, a keyboard and mouse adapter 520, a modem 522, a read only memory (ROM) 524, a hard disk drive (HDD) 526, a CD-ROM drive 530, a universal serial bus (USB) port and other communication ports 532, and PCI/PCIe devices 534 connect to the SB/ICH 504 through bus 538 and bus 540. The PCI/PCIe devices may include, for example, Ethernet adapters, add-in cards, and PC cards for notebook computers. PCI uses a card bus controller, while PCIe does not. ROM 524 may be, for example, a flash basic input/output system (BIOS).

An HDD 526 and a CD-ROM drive 530 connect to the SB/ICH 504 through the bus 540. The HDD 526 and the CD-ROM drive 530 may use, for example, an integrated drive electronics (IDE) or serial advanced technology attachment (SATA) interface. A duper I/O (SIO) device 536 may be connected to SB/ICH 504.

An operating system runs on the processing unit 506. The operating system coordinates and provides control of various components within the data processing system 500 in FIG. 5. As a client, the operating system may be a commercially available operating system. An object-oriented programming system programming system may run in conjunction with the operating system and provide calls to the operating system from programs or applications executing on the data processing system 500. The data processing system 500 may be a symmetric multiprocessor (SMP) system including a plurality of processors in the processing unit 506. Alternatively, a single processor system may be employed.

Instructions for the operating system, the object-oriented programming system, and applications or programs are located on storage devices, such as the HDD 526, and may be loaded into main memory 508 for execution by processing unit 506. The processes for illustrative embodiments may be performed by the processing unit 506 using computer usable program code. The program code may be located in a memory such as, for example, a main memory 508, a ROM 524, or in one or more peripheral devices 526 and 530, for example.

A bus system, such as the bus 538 or the bus 540 as shown in FIG. 5, may be comprised of one or more buses. The bus system may be implemented using any type of communication fabric or architecture that provides for a transfer of data between different components or devices attached to the fabric or architecture. A communication unit, such as the modem 522 or the network adapter 512 of FIG. 5, may include one or more devices used to transmit and receive data. A memory may be, for example, the main memory 508, the ROM 524, or a cache such as found in the NB/MCH 502 in FIG. 5.

Those of ordinary skill in the art will appreciate that the embodiments of FIG. 5 may vary depending on the implementation. Other internal hardware or peripheral devices, such as flash memory, equivalent non-volatile memory, or optical disk drives and the like, may be used in addition to or in place of the hardware depicted in FIG. 5. Further, embodiments of the present disclosure, such as the one or more embodiments may take the form of a computer program product accessible from a computer-usable or computer-readable medium providing program code for use by or in connection with a computer or any instruction execution system. For the purposes of this description, a non-transitory computer-usable or computer-readable medium can be any non-transitory medium that can tangibly embody a computer program and that can contain or store the computer program for use by or in connection with the instruction execution system, apparatus, or device.

In various embodiments, the medium can include an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and digital versatile disk (DVD). The processes of the illustrative embodiments may be applied to a multiprocessor data processing system, such as a SMP, without departing from the spirit and scope of the embodiments.

Moreover, the data processing system 500 may take the form of any of a number of different data processing systems including client computing devices, server computing devices, a tablet computer, laptop computer, telephone or other communication device, a personal digital assistant (PDA), or the like. In some illustrative examples, the data processing system 500 may be a portable computing device that is configured with flash memory to provide non-volatile memory for storing operating system files and/or user-generated data, for example. Essentially, the data processing system 500 may be any known or later developed data processing system without architectural limitation.

Particular embodiments described herein may take the form of an entirely hardware embodiment, an entirely software embodiment or an embodiment containing both hardware and software elements. In a particular embodiment, the disclosed methods are implemented in software that is embedded in processor readable storage medium and executed by a processor, which includes but is not limited to firmware, resident software, microcode, etc.

Further, embodiments of the present disclosure, such as the one or more embodiments may take the form of a computer program product accessible from a computer-usable or computer-readable storage medium providing program code for use by or in connection with a computer or any instruction execution system. For the purposes of this description, a non-transitory computer-usable or computer-readable storage medium may be any apparatus that may tangibly embody a computer program and that may contain, store, communicate, propagate, or transport the program for use by or in connection with the instruction execution system, apparatus, or device.

In various embodiments, the medium may include an electronic, magnetic, optical, electromagnetic, infrared, or semiconductor system (or apparatus or device) or a propagation medium. Examples of a computer-readable storage medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and digital versatile disk (DVD).

A data processing system suitable for storing and/or executing program code may include at least one processor coupled directly or indirectly to memory elements through a system bus. The memory elements may include local memory employed during actual execution of the program code, bulk storage, and cache memories that provide temporary storage of at least some program code in order to reduce the number of times code must be retrieved from bulk storage during execution.

Input/output or I/O devices (including but not limited to keyboards, displays, pointing devices, etc.) may be coupled to the data processing system either directly or through intervening I/O controllers. Network adapters may also be coupled to the data processing system to enable the data processing system to become coupled to other data processing systems or remote printers or storage devices through intervening private or public networks. Modems, cable modems, and Ethernet cards are just a few of the currently available types of network adapters.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and features as defined by the following claims.

1. A method of managing computing node membership, the method comprising:
determining that a node group universally unique identifier has not been assigned to a computing node;
in response to the determination, transitioning the computing node into a first state, wherein the computing node awaits an invitation relating to forming or joining a node group while in the first state;
transitioning the computing node into a second state in response to receiving the invitation to form or join the node group, wherein the computing node awaits an assignment of the node group universally unique identifier while in the second state;
transitioning the computing node into a third state in response to receiving the node group universally unique identifier, wherein the computing node is configured to locate a plurality of neighboring nodes while operating in the third state; and
determining whether a quorum of nodes including the neighboring nodes is present.

2. The method of claim 1, further comprising locating the plurality of neighboring nodes using a non-transmission control protocol/internet protocol (non-TCP/IP).

3. The method of claim 2, further comprising transitioning the computing node into a fourth state in response to determining that the quorum is present, wherein while in the fourth state, the computing node communicates with a neighboring node using TCP/IP.

4. The method of claim 1, further comprising using a list of group members to determine whether the quorum is present.

5. The method of claim 4, further comprising maintaining the list of group members at the computing node.

6. The method of claim 1, further comprising locating the plurality of neighboring nodes using the node group universally unique identifier.

7. The method of claim 1, further comprising receiving at least one of the node group universally unique identifier and the invitation to form or join the node group.

8. The method of claim 1, further comprising designating a link coupled to the computing node as being in a fenced state and allowing only a low-level protocol to a neighboring node.

9. The method of claim 1, further comprising booting the computing node prior to determining that the node group universally unique identifier has not been assigned to the computing node.

10. An apparatus, comprising:
a memory; and
a processor configured to:
access the memory and to execute program code to determine that a node group universally unique identifier has not been assigned to a computing node;
in response to the determination, to transition into a first state awaiting an invitation relating to forming or joining a node group while in the first state;
transition into a second state in response to receiving the invitation to form or join the node group and to await an assignment of the node group universally unique identifier while in the second state;
transition into a third state in response to receiving the node group universally unique identifier and to locate a plurality of neighboring nodes while operating in the third state; and
determine whether a quorum of nodes including the plurality of neighboring nodes is present.

11. The apparatus of claim 10, wherein a non-transmission control protocol/internet protocol (non-TCP/IP) is used to locate the plurality of neighboring nodes.

12. The apparatus of claim 11, wherein the processor is further configured to transition the computing node into a fourth state in response to determining that the quorum is present, wherein while in the fourth state, the processor initiates communication with a neighboring node using TCP/IP.

13. The apparatus of claim 10, wherein the memory stores a list of group members.

14. The apparatus of claim 13, wherein the processor uses the list of group members to determine whether the quorum is present.

15. The apparatus of claim 10, wherein the processor is further configured to locate the plurality of neighboring nodes using the node group universally unique identifier.

16. The apparatus of claim 10, wherein a network interface of the computing node transitions into a fenced state and only allows a low-level protocol to detect the node group universally unique identifier of a neighboring node of the plurality of neighboring nodes.

17. The apparatus of claim 10, wherein a point to point low level mailbox protocol is used to discover the node group universally unique identifier of the plurality of neighboring nodes.

18. The apparatus of claim wherein the computing node is booted prior to determining that the node group universally unique identifier has not been assigned to the computing node.

19. The apparatus of claim 1, wherein a neighboring node of the plurality of neighboring nodes is placed in a service state and is ignored with regard to determining the quorum.

20. A program product, comprising:
program code configured to execute program code to determine that a node group universally unique identifier has not been assigned to a computing node; in response to the determination; to transition into a first state awaiting an invitation relating to forming or joining a node group while in the first state; to transition into a second state in response to receiving the invitation to form or join the node group and to await an assignment of the node group universally unique identifier while in the second state; to transition into a third state in response to receiving the node group universally unique identifier and to locate a plurality of neighboring nodes while operating in the third state, and to determine whether a quorum of nodes including the neighboring nodes is present; and
a computer readable medium bearing the program code.
